(19) United States
(12) Patent Application Publication
(10) Pub. No.: US 2026/0024122 A1
(43) Pub. Date: Jan. 22, 2026

(54) Using a Machine Learning Model to Recommend Items from an Image of a Checkout Line Captured by a Client Device of a Picker Fulfilling an Order

(71) Applicant: Maplebear Inc., San Francisco, CA (US)

(72) Inventors: Axel Mange, New York, NY (US); Sanchit Gupta, Seattle, WA (US)

(21) Appl. No.: 18/775,459

(22) Filed: Jul. 17, 2024

(51) Int. Cl. G06Q 30/0601; G06Q 30/02; G06Q 30/0201

(52) U.S. Cl. CPC G06Q 30/0631; G06Q 30/0201; G06Q 30/0281; G06Q 30/0635

(57) ABSTRACT

An online concierge system receives an order including one or more items from a customer and a picker obtains the items from a retailer. Upon completing obtaining items from the order and moving to checkout from the retailer, the picker updates an order status via a picker application. Via the picker application, the picker may capture an image of a shelf of items in the checkout line. The online concierge system identifies one or more items in the image using image processing and ranks the identified items for the customer from whom the order was received. The online concierge system includes a subset of the identified items ordered based on the ranking in a message to the customer via a communication interface between the customer and the picker. The message indicates the customer can add one or more of the identified items before the picker completes a checkout process.

### BACKGROUND

Online concierge systems receive orders for items from customers and allocate the orders to pickers. A picker to whom an order was allocated obtains items included in the order from a retailer identified by the order to fulfill the order. Subsequently, the picker delivers the obtained items to a location specified in the order by the customer.

As a picker fulfills an order, the picker and the customer from whom the order was received may exchange messages relating to fulfillment of the order. For example, a picker transmits a text-based message to the picker about replacing an item in the order with a replacement item through a picker application on a picker client device. A customer client device displays the text-based message from the picker via a customer application, allowing the customer to respond to the message via the customer application. This allows the customer to provide the picker with information or instructions for fulfilling the order and allows the picker to notify the customer of items that the picker is unable to obtain or other potential difficulties with fulfilling the order.

Additionally, the customer may modify the order while the picker is fulfilling the order. For example, the customer may communicate with the online concierge system to add an item to the order or to modify one or more items included in the order while the picker is fulfilling the order. However, when adding items to an order while the picker is fulfilling the order, the customer is limited to information the online concierge system provides about items available at the retailer. When a customer is physically in a retailer, the customer may purchase items because the customer sees the items in the retailer, which allows the number of items included in an order to easily increase. In contrast, when a picker is fulfilling an order for the customer, the customer is limited to information about items in the retailer provided by the online concierge system, which increases a difficulty of the customer adding items to the order. As the picker is physically in the retailer obtaining items, the customer is unable to quickly see items available at the retailer for inclusion, making impulsive additions of items to an order by the customer more difficult. Making impulsive addition of items to an order by the customer more difficult decreases an amount of interaction with the online concierge system by the customer and decreases an amount of revenue the online concierge system obtains from the customer when fulfilling an order.

### SUMMARY

In accordance with one or more aspects of the disclosure, an online concierge system receives an order from a customer for fulfillment. The order includes one or more items, identifies a retailer from which the one or more items are to be obtained, and identifies a location for the picker to deliver the obtained items. The online concierge system receives the order from a customer client device of the customer, from which the customer identified the one or more items, the retailer, and other attributes of the order.

The online concierge system allocates the order to a picker, who obtains the items included in the order from the identified retailer and delivers the obtained items to the identified location. As the picker fulfills the order, the picker transmits order status information to the online concierge system using a picker client device. In various embodiments, an order status indicates when the picker has performed one or more actions when fulfilling an order. The online concierge system updates the order status of the order based on order status information received from the picker, maintaining a record of the picker’s progress in fulfilling the order. For example, an order status indicates the picker has obtained an item included in the order, while another order status indicates the picker has obtained a replacement item in place of an item included in the order.

When the picker fulfilling the order is approaching a checkout line at the retailer or is in a checkout line at the retailer, the picker transmits an order status indicating the picker is entering the checkout line of the retailer by interacting with a picker application on the picker client device. The checkout line of a retailer is in a physical area within the retailer within a threshold distance of a cash register, a payment kiosk, or another area in the retailer where the picker provides compensation to the retailer for the obtained items. The online concierge system stores the received order status for the order indicating the picker fulfilling the order is in the checkout line in association with the order. In various embodiments, associating an order status indicating the picker fulfilling the order is in the checkout line limits an ability of the customer to add items to the order or to modify the order.

Many retailers include various items in the checkout line, allowing an individual to make last minute purchases of those items while waiting to provide compensation for other items (i.e., waiting to “check out” of the retailer). This positioning of items allows the retailer to obtain additional revenue through impulsive purchases of items near the checkout line by individuals in the retailer. When a picker fulfills an order for the customer, the customer is not physically in the retailer, which prevents the customer from including one or more items near the checkout line in the order. As people often purchase items near the checkout line, the picker’s fulfillment of the order prevents the online concierge system from obtaining revenue from the customer adding one or more items in the checkout line to an order.

To provide the customer from whom the order was received with the ability to add items in the checkout line to the order, the picker captures an image of items in the checkout line at the retailer using the picker client device. Items “in the checkout line” are items having physical locations in the retailer within a physical area of the retailer where the picker provides the retailer with compensation for obtained items (i.e., “checks out” of the retailer). Items in the checkout line may be items within a threshold distance of the physical area where the picker checks out of the retailer in various embodiments. For example, items in the checkout line are items with physical locations on one or more shelves within a threshold distance of a physical area where the picker checks out of the retailer that includes a physical location of the picker client device within the retailer. The picker captures the image of the items in the checkout line using a camera or another image capture device included in the picker client device or otherwise connected to the picker client device. In various embodiments, the picker client device transmits the order status indicating the picker is entering the checkout line to the online concierge system then transmits the captured image to the online concierge system. Alternatively, the picker client device transmits the order status indicating the picker is entering the checkout line in conjunction with the captured image.

In various embodiments, the online concierge system applies one or more image processing models or one or more computer vision models to the captured image to identify items included in the captured image. In various embodiments, the online concierge system 140 identifies different portions of the captured image including candidate items and compares each identified portion of the captured image to images of items included in an item catalog for the retailer. The online concierge system identifies an item in the item catalog for the retailer in the captured image in response to at least a threshold amount of attributes of an image of the item in the item catalog matching attributes of the portion of the captured image. Example attributes of an image of the item include a machine-readable code (e.g., a bar code, a QR code) on a package of the item, a label on a package of the item, packaging of the item, an image or other identifier of an entity associated with the item, or other visual attributes of packaging of the item. Identifying one or more items from the captured image leverages information from the captured image to identify items in the checkout line where the picker is located, providing the online concierge system with current information about items in the retailer that are within a threshold distance of the picker while in the checkout line.

Based on characteristics of the customer from whom the order was received and attributes of each identified item from the captured image, the online concierge system selects a subset of the identified items. In various embodiments, the online concierge system determines a probability of the customer from whom the order was received performing a specific action (e.g., including an identified item in the order) for each identified item. The online concierge system may determine the probability for an identified item by applying one or more models to a combination of the identified item and the customer. In some embodiments, the online concierge system ranks the identified items based on their corresponding probabilities and selects identified items having at least a threshold position in the ranking as the subset of identified items.

In some embodiments, the online concierge system accounts for compensation received from the retailer or from an entity associated with one or more identified items in response to the customer performing the specific interaction with the identified item. For example, the online concierge system generates a score for each identified item, with a score for an identified item based on a combination of a predicted probability of the customer performing the specific interaction with the identified item and an amount of compensation the online concierge system receives in response to the customer performing the specific interaction with the item. To generate the score for an identified item, the online concierge system applies a conversion factor to one or more of the predicted probability and the amount of compensation, with the conversion factor converting the predicted probability and the amount of compensation into a common unit of measurement. After application of the conversion factor, the online concierge system generates a score for an identified item by combining (e.g., adding) the predicted probability and the amount of compensation and ranks the identified items by their corresponding scores to select the subset of identified items.

To simplify selection of an identified item for inclusion in the order, the online concierge system generates a message including information describing various identified items of the subset. In various embodiments, the message includes text content and information describing various identified items of the subset in some embodiments. The text content may specify a time interval until the picker begins checking out of the retailer, providing the customer with a length of time that the customer may add one or more of the identified items to the order. In some embodiments, the message includes a carousel portion that includes a plurality of slots, with each slot presenting information describing a different identified item of the subset. For example, each slot in the carousel portion includes an image and a name (or a description) of an item of the subset. Other information describing an identified item may be retrieved from the item catalog for the retailer. Additional examples of information describing an identified item include: a size of the identified item, a price of the identified item at the retailer, a weight of the item, nutritional information of the item, or other descriptive attributes of the item. In various embodiments, the message presents information describing different identified items of the subset in an order based on the ranking used to select the subset. For example, the message includes different slots for presenting information describing different identified items, with each slot associated with a position in the ranking. So, a specific slot presents information describing an identified item of the subset having a position in the ranking associated with the specific slot. This allows the message to present certain identified items in positions that increase a probability of the customer selecting one or more of the certain identified items.

The online concierge system transmits the message to the customer client device of the customer for presentation. In various embodiments, the customer client device presents the message via a communication interface that includes text-based messages exchanged between the customer and the picker. For example, the picker and the customer exchange text-based messages as the picker fulfills the order, allowing the customer to provide information or feedback to the picker for fulfilling the order. The communication interface may present the message as originating from the picker in some embodiments. Including the message via the communication interface increases a likelihood of the customer viewing or interacting with the message by using an interface through which the customer and picker exchanged content to present the message to the customer.

In response to receiving a specific action by the customer with information describing an identified item of the subset included in the message, the customer client device transmits a selection of the identified item to the online concierge system, which updates the order to include the selected identified item. The online concierge system also transmits an identification of the selected identified item to the picker client device in a request for the picker to obtain the selected identified item. This allows the customer to easily select one or more items near the picker for inclusion in the order while the picker checks out from the retailer, providing increased flexibility to the customer for adding various items to the order and increasing an amount of time when the customer may add items to the order.

In response to receiving a modified order status from the picker, such as an order status indicating the picker has completed checking out from the retailer, the online concierge system prevents the customer from selecting an identified item via the message. For example, in response to receiving a modified order status from the picker indicating the picker has completed checking out of the retailer, the online concierge system transmits an instruction to the client device that disables selection of an identified item from the message via the communication interface. The online concierge system may transmit an additional message to the customer client device in response to receiving the modified order status from the picker, with the additional message indicating that the customer is no longer able to include an identified item from the message in the order. This prevents the customer from attempting to select one or more identified items for inclusion in the order after the picker has completed checking out from the retailer.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an interaction diagram of a method for identifying items available for inclusion in an order to a customer based on an image of items in a checkout line at a retailer from a picker fulfilling the order, in accordance with one or more embodiments.

FIG. 4 illustrates an example communication interface presenting messages between a picker and a customer, in accordance with one or more embodiments.

FIG. 5 illustrates a process flow diagram of a method for identifying items available for inclusion in an order to a customer based on an image of items in a checkout line at a retailer from a picker fulfilling the order, in accordance with one or more embodiments.

### DETAILED DESCRIPTION

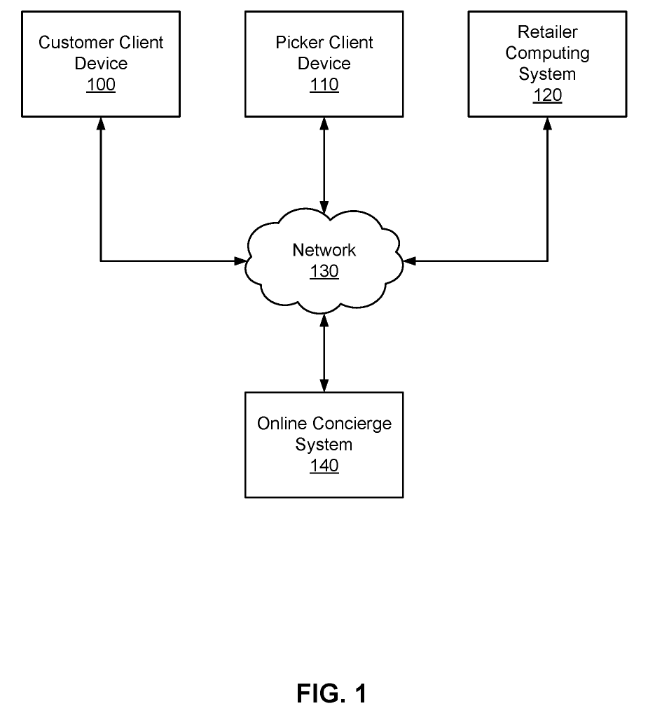

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the customer and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the customer has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer’s order. This communication interface allows the customer to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

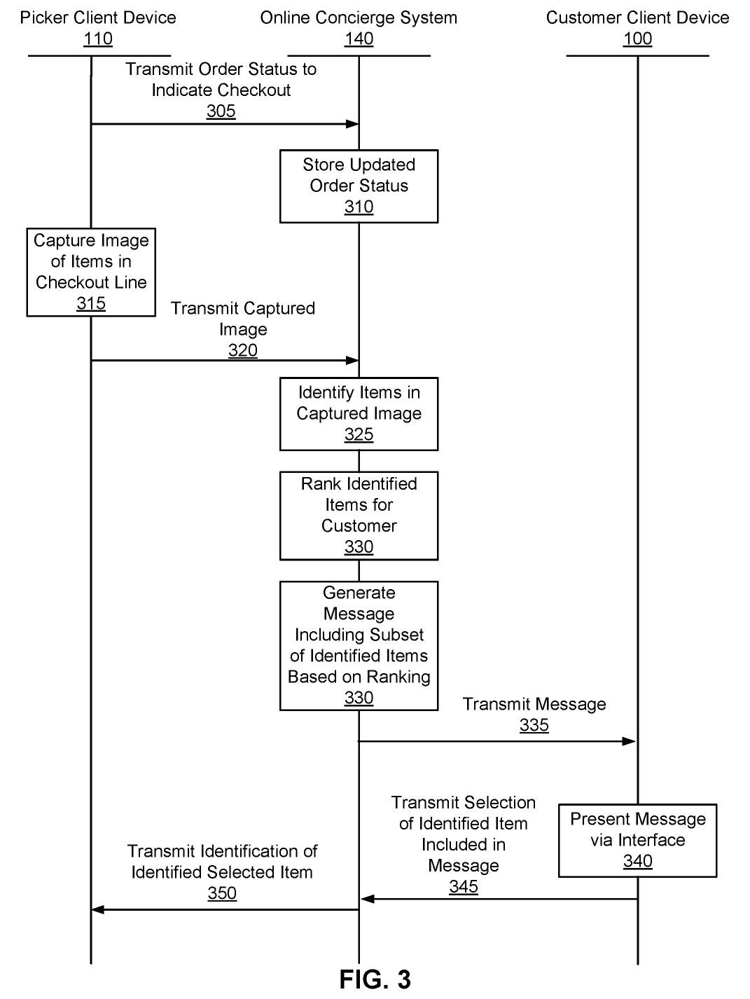

In various embodiments, the communication interface of the customer client device 100 displays one or more messages generated by the online concierge system 140. As further described below in conjunction with FIGS. 3–5, the online concierge system 140 leverages an image captured by the picker client device 110 to identify one or more items in a checkout line of a retailer and includes information describing a subset of the identified items in a message presented to a customer via the communication interface of the client device 100. The customer may select one or more of the identified items via an interaction with the message via the communication interface to include the selected identified item in an order, as further described below in conjunction with FIGS. 3–5. Describing the identified items in a message via the communication interface increases a likelihood of the customer viewing the message and selecting one or more of the identified items for inclusion in the order.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a picker application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer’s order to the picker in a collection interface. The collection interface is a user interface that provides information to the picker on which items to collect for a customer’s order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When fulfilling an order for a customer, a picker interacts with a picker application executing on the picker client device 100 to provide an order status to the online concierge system 140. Different order statuses correspond to different actions performed by the picker when fulfilling the order. For example, an order status indicates the picker has obtained an item, while another order status indicates the picker was unable to obtain the item. The online concierge system 140 receives an identifier of an order and an order status from the picker client device 110 and updates an order status associated with the order to reflect the order status received from the picker client device 110.

Additionally, the picker application provides a communication interface to the picker. By interacting with the communication interface, the picker transmits messages about order fulfillment to a customer client device 100 and receives messages about order fulfillment from the customer client device 100. A message may include one or more images of items captured using an image capture device or a camera of the picker client device 110. For example, a message from a picker includes an image of one or more replacement items for selection by a customer when the picker is unable to obtain an item included in an order from a retailer. Messages transmitted or received via the communication interface are text-based messages in various embodiments. Additionally, one or more images captured by the picker client device 110 may be transmitted to the online concierge system 140 from the picker device 110, as further described below in conjunction with FIGS. 3–5.

When the picker has collected all of the items for an order, the picker client device 110 instructs a picker on where to deliver the items for a customer’s order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker’s location. For example, if the picker takes a wrong turn while traveling to a delivery location, the online concierge system 140 determines the picker’s updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a customer’s order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer’s order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

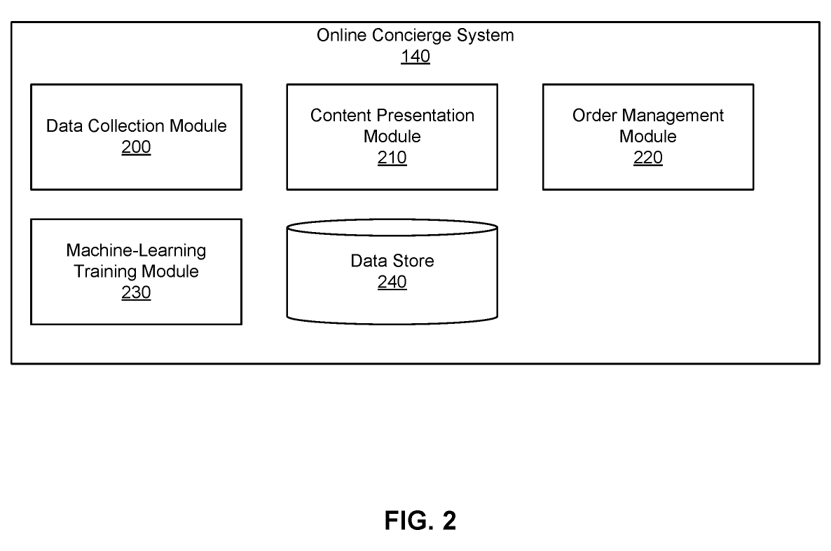

As an example, the online concierge system 140 may allow a customer to order groceries from a grocery store retailer. The customer’s order may specify which groceries they want delivered from the grocery store and the quantities of each of the groceries. The customer client device 100 transmits the customer’s order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer’s name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer’s interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online concierge system 140, a customer rating for the picker, which retailers the picker has collected items at, or the picker’s previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100 and assigns the orders to pickers for service based on picker data. For example, the order management module 220 assigns an order to a picker based on the picker’s location and the location of the retailer location from which the ordered items are to be collected. The order management module 220 may also assign an order to a picker based on how many items are in the order, a vehicle operated by the picker, the delivery location, the picker’s preferences on how far to travel to deliver an order, the picker’s ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker’s current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer’s order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

The order management module 230 receives various order statuses from a picker fulfilling an order and maintains an order status for the order. In various embodiments, the order status associated with the order by the order management module 230 is a most recently received order status from the picker fulfilling the order. The order management module 230 receives the order status for the order from a picker client device 110 of a picker fulfilling the order. In various embodiments, interactions with the picker application on the picker client device 110 by the picker identify one or more actions performed by the picker while fulfilling the order, and the picker client device 110 transmits one or more of the identified actions to the online concierge system 140 as an order status of the order. Updating the order status of the order as the picker performs different actions allows the order management module 230 to maintain information describing progress of the picker in fulfilling an order.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

In various embodiments, the order management module 230 generates one or more messages for the customer that are transmitted to a customer client device 100 for presentation. For example, the order management module 230 identifies items proximate to a picker from an image captured by the picker and includes information describing one or more of the identified items in a message transmitted to the customer client device 100 for presentation in a communication interface, as further described below in conjunction with FIGS. 3–5. The order management module may apply one or more large language models to information about a picker to generate the message including the information describing the one or more identified items. The one or more identified items described by the message are selected by the order management module 230 based on a ranking of the identified items for a particular customer, such as a ranking based on probabilities of the customer performing a specific interaction with each identified item, as further described below in conjunction with FIG. 3. Similarly, the order management module 230 may apply one or more computer vision models or object identification models to an image from a picker client device 110 to identify items offered by a retailer included in the image. Generation of a message based on an image captured by a picker client device 110 is further described below in conjunction with FIGS. 3–5.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

In various embodiments, the machine learning training module 230 trains a model to determine a probability of a customer performing a specific interaction with an item based on characteristics of the customer and attributes of the item. For example, the model generates a probability of the customer including an item in an order based on characteristics of the customer and attributes of the item. However, in different embodiments, the model predicts a probability of the customer performing a different interaction with the item.

To train the model, the machine learning training module 230 obtains a training dataset including a plurality of training examples. Each training example includes characteristics of a training customer and attributes of an item, with a label applied to each training example indicating whether the training customer performed the specific interaction with the item. The machine learning training module 230 applies the model to each training example. Application of the model to a training example generates a predicted probability of the training customer performing the specific interaction with the item. Using a loss function, the machine learning training module 230 scores the model based on the label applied to a training example and the predicted probability of the training customer performing the specific interaction with the item. In various embodiments, the score is based on a difference between the label applied to a training example and the predicted probability of the training customer performing the specific interaction with the item, with a smaller difference resulting in a lower score and a larger difference resulting in a higher score. The machine learning training module 230 modifies one or more parameters of the model through backpropagation based on the scores until one or more criteria are satisfied (e.g., until the score for the model is less than a threshold value).

The machine learning training module 230 may train or store one or more generative models in various embodiments. A generative model is configured to receive a prompt including text or one or more images as input and to generate text data as output. For example, a generative model is a large language model (LLM) previously trained on a large text or image corpus to determine a relationship between different portions of text. Based on the determined relationships, the generative model generates output text that is presented to a user, such as a customer or a picker.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

FIG. 3 is an interaction diagram of a method for identifying items available for inclusion in an order to a customer based on an image of items in a checkout line at a retailer from a picker fulfilling the order, in accordance with some embodiments. Alternative embodiments may include more, fewer, or different steps from those illustrated in FIG. 3, and the steps may be performed in a different order from than illustrated in FIG. 3. These steps may be performed by an online concierge system (e.g., online concierge system 140). Additionally, each of these steps may be performed automatically by the online concierge system without human intervention.

The online concierge system 140 receives an order from a customer for fulfillment. In various embodiments, the online concierge system 140 receives the order from a customer client device 100 of the customer. The order includes one or more items and identifies a retailer from which the items are to be obtained. Additionally, the order includes a location where the items are to be delivered and a time interval when the customer expects the items to be delivered to the location. In various embodiments, the order includes additional or alternative characteristics related to obtaining and delivering items to a location. After receipt, the online concierge system 140 allocates the order to a picker for fulfillment.

The picker to whom the order was allocated fulfills the order by obtaining items included in the order from the retailer identified in the order. Using a picker application executing on a picker client device 110, the picker provides various order statuses to the online concierge system 140. For example, an order status identifies an action the picker completed or performed while fulfilling the order or provides other information describing order fulfillment by the picker. As an example, the picker transmits an indication that the picker has obtained an item in the order to the online concierge system 140 as an order status via the picker application. In another example, the picker transmits a replacement notification that the picker replaced an item included in the order with a replacement item to the online concierge system 140 as an order status via the picker application.

Additionally, an order status from the picker may indicate when the picker is performing certain actions. One such action is when the picker is entering a checkout line at the retailer. The checkout line of a retailer is in a physical area within the retailer within a threshold distance of a cash register, a payment kiosk, or another area in the retailer where the picker provides compensation to the retailer for the obtained items. In one or more embodiments, when the picker is approaching a checkout line at the retailer or is in a checkout line at the retailer, the picker interacts with the picker application to transmit 305 an order status indicating the picker is entering the checkout line at the retailer. The online concierge system 140 stores 310 an updated order status for the order in association with the order indicating the picker fulfilling the order is in the checkout line. In one or more other embodiments, the process may occur when the picker approaches an area at the retailer other than the checkout line, such as an endcap, where spontaneous purchases may also be made.

In addition to transmitting 305 the order status indicating the picker is entering the retailer’s checkout line, the picker captures 315 an image of items in the checkout line. Items “in the checkout line” are items with physical locations in the retailer within a physical area of the retailer where the picker provides the retailer with compensation for obtained items (i.e., “checks out” of the retailer) or are items within a threshold distance of the physical area where the picker checks out of the retailer in various embodiments. For example, items in the checkout line are items with physical locations on one or more shelves within a threshold distance of a checkout line including a physical location of the picker client device 110 within the retailer. Through one or more interactions with the picker application, the picker captures 315 the image of items in the checkout line using an image capture device or camera of the picker client device 110.

The picker client device 110 transmits 320 the captured image of items in the checkout line to the online concierge system 140, which applies one or more object recognition models, or other image recognition models, to the captured image to identify 325 items in the captured image. In some embodiments, the picker client device 110 transmits 320 the captured image to the online concierge system 140 after transmitting 305 the order status indicating the picker is in the retailer’s checkout line. Alternatively, the picker client device transmits 320 the captured image to the online concierge system 140 in conjunction with the order status indicating the picker is in the retailer’s checkout line.

In various embodiments, the online concierge system 140 identifies discrete items in the captured image through one or more computer vision models. For each item in the captured image, the online concierge system 140 compares a portion of the captured image including an item to images of items included in an item catalog for the retailer. The online concierge system 140 identifies 325 an item in the captured image as an item included in an item catalog for the retailer associated with one or more images having a threshold amount of attributes matching attributes of the portion of the captured image. Different attributes of the portion of the image may be compared to attributes of images of one or more items to identify 325 one or more items in the captured image. Example attributes of an image of the item include a machine-readable code (e.g., a bar code, a QR code) on a package of the item, a label on a package of the item, packaging of the item, an image or other identifier of an entity associated with the item, or other visual attributes of packaging of the item. Comparing the portion of the captured image to images of items in the item catalog of the retailer leverages information maintained by the online concierge system 140 about items offered by the retailer to identify 325 items more efficiently in the captured image.

Based on characteristics of the customer from whom the order was received and attributes of each identified item (e.g., attributes of an identified item associated with the identified item by the item catalog of the retailer), the online concierge system 140 ranks 330 the identified items. In various embodiments, the online concierge system 140 applies one or more trained machine learning models to each combination of characteristics of the customer and attributes of an identified item, with a model generating a probability of the customer performing a specific interaction with the identified item. For example, the online concierge system 140 applies a trained machine learning model to predict a probability that the customer will add an item to the order, for each combination of the customer and an identified item. Based on the predicted probabilities, the online concierge system 140 ranks 330 the identified items for the customer. In various embodiments, the online concierge system 140 ranks 330 the identified items so identified items with higher corresponding probabilities have higher positions in the ranking.

For example, a model generating a probability of a customer performing a specific interaction with an item comprises a set of weights stored on a non-transitory computer readable storage medium. The online concierge system 140 trains the model by generating a training dataset including multiple training examples. Each training example includes characteristics of a training customer and attributes of an item. In various embodiments, to generate the training dataset, the online concierge system 140 retrieves prior orders from the data store 240 associated with the customer, associated with additional customers in a common geographic region as the customer, or associated with other customers. Each training example has a label indicating the training customer included in the training example performed the specific interaction with the item included in the training example. For example, the label of a training example has a particular value when the training customer in the training example included the item in the training example in an order and has an alternative value when the training customer did not include the item in the training example in an order.

To train the model, the online concierge system 140 initializes the set of weights comprising the model and applies the model to multiple training examples of the training dataset. Applying the model to multiple training examples generates the parameters (e.g., the weights) for the model. The parameters comprising the model transform the input data – characteristics of a customer and attributes of an item – into a probability of the customer performing the specific interaction with the item (e.g., including the item in an order). When applied to a training example, the model generates a predicted probability of the training customer of the training example performing the specific interaction with the item included in the training example.

For each training example to which the model is applied, the online concierge system 140 generates a score comprising an error term based on a predicted probability of the training customer performing the specific interaction with the item included in the training example generated by the model and the label applied to the training example. The error term is larger when a difference between the predicted probability of the training customer performing the specific interaction with the item included in the training example and the label applied to the order classification training example is larger and is smaller when the difference between the predicted probability of the training customer performing the specific interaction with the item included in the training example and the label applied to the training example is smaller. In various embodiments, the online concierge system 140 generates the error term using a loss function based on a difference between the predicted probability of the training customer performing the specific interaction with the item included in the training example and the label applied to the training example using a loss function. Example loss functions include a mean square error function, a mean absolute error, a hinge loss function, and a cross-entropy loss function.

The online concierge system 140 backpropagates the error term to update the set of parameters comprising the model and stops backpropagation in response to the error term, or to the loss function, satisfying one or more criteria. For example, the online concierge system 140 backpropagates the error term through the model to update parameters of the proactive remediation model until the error term has less than a threshold value. For example, the online system 140 may apply gradient descent to update the set of parameters. The online concierge system 140 stores the set of parameters comprising the model on a non-transitory computer readable storage medium after stopping the backpropagation.

In some embodiments, when ranking 330 the identified items, the online concierge system 140 also accounts for compensation received from the retailer or from an entity for one or more items in response to the customer performing the specific interaction with an item. For example, the online concierge system 140 generates a score for each identified item, with a score for an identified item based on a combination of a predicted probability of the customer performing the specific interaction with the identified item and an amount of compensation the online concierge system 140 receives (e.g., from the retailer, from an entity associated with the identified item) in response to the customer performing the specific interaction with the identified item. In various embodiments, the online concierge system 140 applies a conversion factor to predicted probability or to the amount of compensation, with the conversion factor converting the predicted probability and the amount of compensation into a common unit of measurement. After application of the conversion factor, the online concierge system 140 combines (e.g., adds) the predicted probability and the amount of compensation for an identified item to generate a score for the identified item, then ranks 330 the identified items by their corresponding scores. This allows the online concierge system 140 to increase a position in the ranking of one or more identified items based on an amount of compensation the online concierge system 140 receives in exchange for the customer performing the specific interaction with one or more identified items.

Based on the ranking 330, the online concierge system 140 selects a subset of the identified items and generates 335 a message including the selected subset of the identified items. For example, the online concierge system 140 may select identified items having at least a threshold position in the ranking as the subset of the identified items and generates 335 a message including the selected subset of the identified items. As another example, the online concierge system 140 selects the subset of identified items as identified items having at least a threshold probability of the customer performing the specific interaction or having at least a threshold score. In various embodiments, the message includes information describing each identified item of the subset. For example, the message includes text indicating the picker is in the checkout line at the retailer and information identifying at least some identified items of the subset. In some embodiments, the message also identifies an amount of time before the picker completes checking-out of the retailer. The online concierge system 140 allows the customer to add one or more items to the order until the picker completes checking-out, so identifying the amount of time until checking-out is completed provides the customer with a time interval within which the customer may include one or more of the identified items of the subset to the order. In various embodiments, the online concierge system 140 prevents the customer from adding items other than those included in the message to the order in response to receiving the order status from the picker client device 110 that the picker is in the retailer’s checkout line.

The online concierge system 140 transmits 335 the message to a customer client device 100 of the customer, which presents 340 the message to the customer through a communication interface. As further described above in conjunction with FIG. 1, the communication interface allows the customer to communicate with the picker fulfilling the order. In various embodiments, the communication interface displays text-based messages from the picker, or from the online concierge system 140, to the customer via the customer client device 100. Similarly, the communication interface receives input from the customer via the customer client device 100 generating a text-based message for the picker; the customer client device 100 transmits the text-based message to the picker client device 110 (via the online concierge system 140 in various embodiments) for presentation to the picker. Hence, the communication interface facilitates exchange of information about order fulfillment between the customer and the picker, so presenting 340 the message including the subset of the identified items via the communication interface increases a likelihood of the customer viewing the message and selecting one or more of the identified items. Other types of interactions by the customer with the communication interface cause different types of information to be transmitted from the customer client device 100 to the online concierge system 140. Moreover, the interactions by the customer with the communication interface may be used as additional training examples to re-train the machine learning model used to predict the users’ interactions.

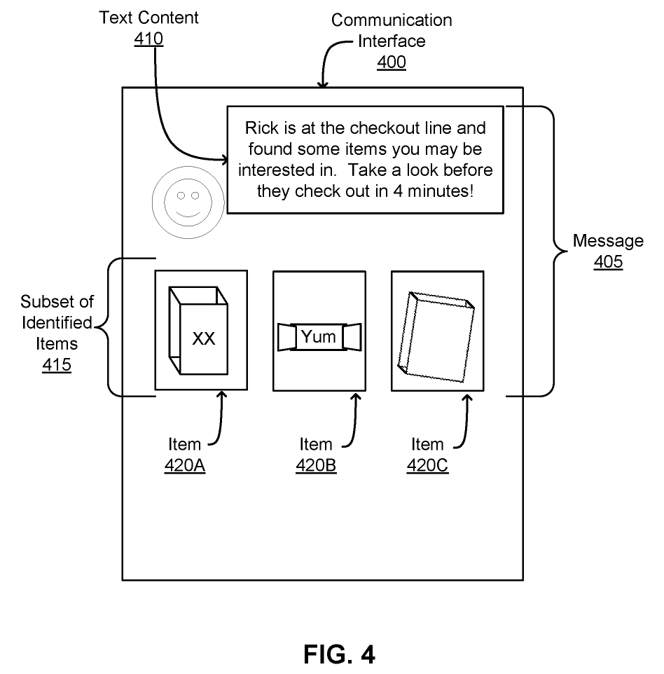

For purposes of illustration, FIG. 4 shows an example communication interface 400 including information describing a subset of items identified from an image captured by a picker client device 110. As shown in FIG. 4, the communication interface 400 presents a message 405 generated by the online concierge system 140 including text content 410 and a subset 415 of identified items from a captured image of items in a checkout line of a retailer. In various embodiments, the text content 410 is generated by the online concierge system 140 based on one or more templates stored by the online concierge system 140. Alternatively, the online concierge system 140 generates a prompt for a generative model, such as a large language model, which generates the text content 410 based on the prompt. For example, the prompt includes an instruction to generate text indicating the picker is checking out, an identifier of the picker, and an estimated amount of time until the picker completes checking out of the retailer. Based on the instruction and received information in the prompt, the generative model generates the text content 410 for the message 405. In various embodiments, the text content 410 includes an identifier of the picker fulfilling the order, an indication the picker is in a checkout line at the retailer, and an amount of time until the picker completes checking out of the retailer. However, in other embodiments, the text content 410 includes different or additional information.

As further described above in conjunction with FIG. 3, the online concierge system 140 receives an image of items in a checkout line of a retailer from the picker client device 110 of the picker fulfilling the order. The online concierge system 140 identifies items included in the captured image through one or more computer vision models or object recognition models and ranks the identified items for presentation to the customer. As further described above in conjunction with FIG. 3, the online system 140 ranks the identified items based on corresponding probabilities of the customer performing a specific interaction with each identified item and selects a subset of the identified items based on the ranking in various embodiments. In other embodiments, the online concierge system 140 may rank the identified items using other criteria or using a combination of criteria. Based on the ranking, the online concierge system 140 selects the subset 415 of identified items in various embodiments. For example, the online concierge system 140 selects the subset 415 of identified items as identified items having at least a threshold position in the ranking. The online concierge system 140 may select the subset 415 of identified items using different or additional criteria in some embodiments.

When generating the message 405, the online concierge system 140 combines the text content 410 with information describing one or more identified items of the subset 415. In the example of FIG. 4, the subset 415 of identified items includes item 420A, item 420B, and item 420C. The message 405 includes information describing each of item 420A, item 420B, and item 420C in conjunction with the message 405. For example, the message 405 includes an image of item 420A, an image of item 420B, and an image of item 420C. The message 405 may additionally or alternatively include a name or a description of each if item 420A, item 420B, and item 420C. Other information describing an identified item may be retrieved from the item catalog for the retailer by the online concierge system 140 and included in the message 405 to describe the identified item. Additional examples of information describing an identified item include: a size of the identified item, a price of the identified item at the retailer, a weight of the item, nutritional information of the item, or other descriptive attributes of the item. The online concierge system 140 may select different attributes to describe different identified items in various embodiments.

In some embodiments, the message includes a carousel portion having multiple slots. Each slot in the carousel portion displays information describing an item of the subset 415. The carousel portion includes a specific number of slots, limiting a number of identified items that are included in the message 405. For example, a first slot in the carousel portion displays information describing item 420A, a second slot in the carousel portion displays information describing item 420B, and a third slot in the carousel portion displays information describing item 420C. In response to the messaging interface 400 receiving a specific interaction with the carousel portion from the customer, the carousel portion changes one or more slots displayed by the message 405. For example, in response to the customer performing a specific gesture with the carousel portion via an input device of the customer client device 100, the carousel portion displays a fourth slot in place of the first slot; in response to the customer performing an alternative gesture with the carousel portion via the input device of the customer client device 100, the carousel portion displays the first slot in place of the fourth slot. This allows the carousel portion to have more slots than are capable of being displayed at one time by a display of the customer client device 100 and allows the customer to modify which slots of the carousel portion are displayed in the message 405 through interaction with the carousel portion.

The message 405 displays information describing different identified items of the subset 415 in a sequence based on the ranking of identified items used to select the subset 415 in various embodiments. For example, the message includes multiple slots, with each slot displaying information describing an identified item of the subset 415. The online concierge system 140 maintains associations between positions in the rankings and different slots, so information describing an identified item of the subset 415 is displayed in a slot corresponding to a position in the ranking of the identified item of the subset 415. For example, a highest position in the ranking of the identified items is associated with a leftmost slot and a second highest position in the ranking of the identified items is associated with an additional slot to the right of the leftmost slot and adjacent to the leftmost slot. This allows the online concierge system 140 to present information describing different items 420 in different slots to increase a likelihood of the customer viewing or interacting with information describing certain items 420.

Referring back to FIG. 3, while the customer client device 100 presents 340 the message via the communication interface, the customer may perform one or more interactions with the message via the communication interface. In various embodiments, the customer selects an identified item via the message by performing a specific interaction with a portion of the message. For example, the customer performs a particular interaction with a slot in the message displaying information describing an identified item to select the identified item or performs the particular interaction with a portion of the message displaying information describing the identified item. In response to the customer client device 100 receiving a selection of an identified item via the message, the customer client device 100 transmits 345 the selection of the identified item to the online concierge system 140. For example, the customer client device 110 transmits a request to add the selected identified item to the order that includes an identifier of the selected identified item, an identifier of the customer, and an identifier of the order to the online concierge system 140.

The online concierge system 140 receives the selection of the identified item from the customer client device 110 and transmits 350 an identification of the selected identified item to the picker client device 110. For example, the online concierge system 140 transmits 350 a request including an identifier of the selected identified item and an instruction to add the selected identified item to the order. Additionally, the online concierge system 140 modifies the order from the customer to include the selected identified item and stores the modified order. For example, the online concierge system 140 updates the order to include the selected identified item and updates a cost of the order by increasing a prior cost of the order by a cost of the selected identified item. As the captured image included items in the checkout line, describing one or more items identified 325 from the captured image in the message notifies the customer of items readily available to the picker while the picker is checking out of the retailer. This allows the customer to easily include one or more of the identified items, which are proximate to the picker fulfilling the order when checking out of the retailer, simplifying addition of certain items to the order by the customer while the picker fulfilling the order is checking out of the retailer.

In various embodiments, the online concierge system 140 limits an ability of the customer to add items to the order after storing 310 the order status that the picker is entering the checkout line. In such embodiments, the online concierge system 140 prevents the customer from adding items to the order other than the items identified to the customer via the message. Such limitation of items capable of being added to the order streamlines order fulfillment by limiting addition of items to the order to items in the checkout line rather than items generally available in the retailer while the picker is entering the checkout line.

The online concierge system 140 prevents the customer from selecting an identified item via the message in response to receiving a modified order status from the picker. In various embodiments, in response to receiving a modified order status that the picker has completed checking out of the retailer, the online concierge system 140 transmits an instruction to the client device 100 disabling selection of an identified item via the communication interface. The online concierge system 140 also transmits an additional message to the customer client device 100 in response to receiving the modified order status from the picker, with the additional message indicating that the customer is no longer able to include an identified item from the message in the order. In various embodiments, the online concierge system 140 transmits the additional message and the instruction to the customer client device 100 in response to receiving a specific modified order status from the picker client device 110, such as in response to receiving a modified order status indicating the picker has completed checking out from the retailer. This notifies the customer that the customer is no longer able to add one or more of the identified items to the order. Hence, the online concierge system 140 leverages the captured image to enable the customer to include one or more items identified 325 from the captured image to the order while the picker is in the checkout line, but prevents the customer from including one or more of the identified items after the picker has completed checking out of the retailer.

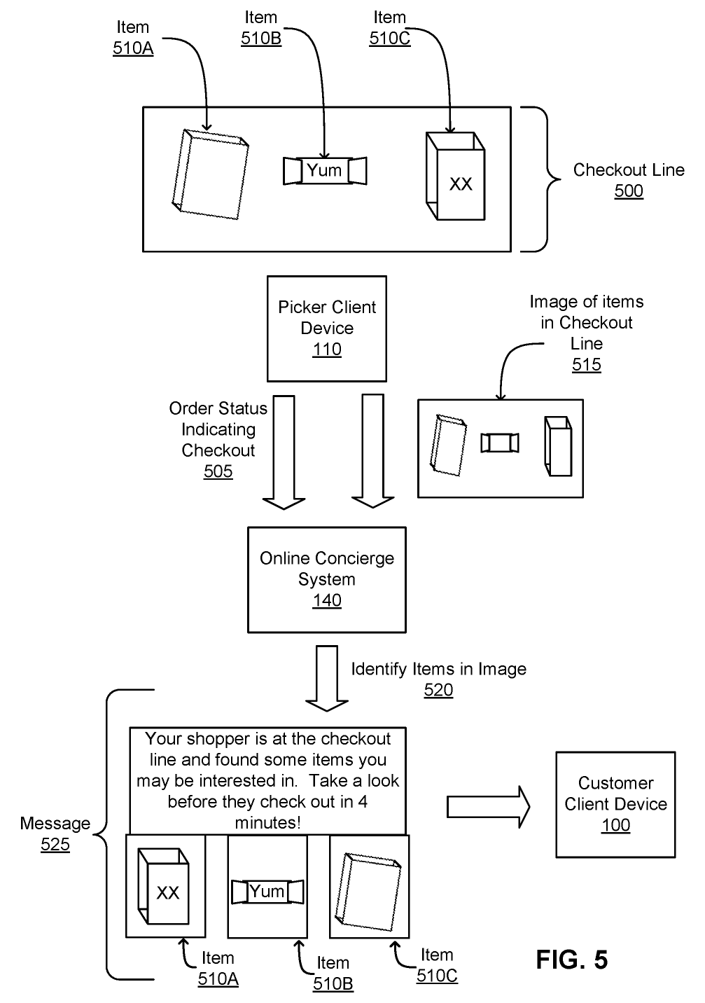

FIG. 5 is a process flow diagram of a method for identifying items available for inclusion in an order to a customer based on an image of items in a checkout line at a retailer from a picker fulfilling the order. As further described above in conjunction with FIGS. 1–3, an online concierge system 140 receives an order from a customer for fulfillment. The order includes one or more items, identifies a retailer from which the one or more items are to be obtained, and identifies a location for the picker to deliver the obtained items. The online concierge system 140 receives the order from a customer client device 100 of the customer, as further described above in conjunction with FIGS. 1–3.

The online concierge system 140 allocates the order to a picker, who obtains the items included in the order from the identified retailer and delivers the obtained items to the identified location. As the picker fulfills the order, the picker transmits order status information to the online concierge system using a picker client device 110. As further described above in conjunction with FIG. 3, an order status indicates when the picker has performed one or more actions when fulfilling an order. For example, an order status indicates the picker has obtained an item included in the order, while another order status indicates the picker has obtained a replacement item in place of an item included in the order.

When the picker fulfilling the order is approaching a checkout line 500 at the retailer or is in a checkout line 500 at the retailer, the picker interacts with a picker application on the picker client device 110 to transmit an order status 505 indicating the picker is entering the checkout line 500 at the retailer. The checkout line of a retailer is a physical area within the retailer within a threshold distance of a cash register, a payment kiosk, or an area in the retailer where the picker provides compensation to the retailer for the obtained items. The online concierge system 140 stores the order status 505 indicating the picker fulfilling the order is in the checkout line 500 in association with the order. In various embodiments, associating an order status indicating the picker fulfilling the order is in the checkout line limits an ability of the customer to add items to the order or to modify the order.

Many retailers include various items in the checkout line 500, allowing an individual to make last minute purchases of items in the checkout line 500 while waiting to provide compensation for other items (i.e., waiting to “check out” of the retailer). This positioning of items allows the retailer to obtain additional revenue from impulsive purchases by individuals in the retailer of items near the checkout line 500. When a picker fulfills an order for the customer, the customer is not physically in the retailer, so the customer is unable to one or more items near the checkout line 500 in an order while checking out of the retailer. As people often purchase items near the checkout line 500, order fulfillment by the picker prevents the online concierge system 140 from obtaining revenue from the customer adding one or more items in the checkout line 500 to the order. In the example of FIG. 5, the retailer has item 510A, item 510B, and item 510C (also referred to individually and collectively using reference number 510) in the checkout line 500.

To provide the customer from whom the order was received with the ability to add items in the checkout line 500 to the order while the picker is waiting to check out of the retailer, the picker captures an image 515 of items 510 in the checkout line 500 at the retailer using the picker client device 110. Items “in the checkout line” are items with physical locations in the retailer within a physical area of the retailer where the picker provides the retailer with compensation for obtained items (i.e., “checks out” of the retailer) or are items within a threshold distance of the physical area where the picker checks out of the retailer in various embodiments. For example, items in the checkout line 500 are items with physical locations on one or more shelves within a threshold distance of a checkout location that includes a physical location of the picker client device 110 within the retailer. The picker captures the image 515 of the items 510 in the checkout line 500 using a camera or another image capture device included in the picker client device 110 or otherwise connected to the picker client device 110. In various embodiments, the picker client device 110 transmits the order status 505 indicating the picker is entering the checkout line 500 to the online concierge system 140 then transmits the captured image 515 to the online concierge system 140. Alternatively, the picker client device 110 transmits the order status 505 indicating the picker is entering the checkout line 500 to the online concierge system 140 in conjunction with the captured image 515.

As further described above in conjunction with FIG. 3, the online concierge system 140 applies one or more image processing models or one or more computer vision models to the captured image 515 to identify 520 items included in the captured image 515. In various embodiments, the online concierge system 140 identifies 520 different portions of the captured image 515 including candidate items and compares each identified portion of the captured image 515 to images of items included in an item catalog for the retailer. Example attributes of an image of the item include a machine-readable code (e.g., a bar code, a QR code) on a package of the item, a label on a package of the item, packaging of the item, an image or other identifier of an entity associated with the item, or other visual attributes of packaging of the item. The online concierge system 140 identifies 520 an item in the item catalog for the retailer in the captured image 515 in response to at least a threshold amount of attributes of an image of the item in the item catalog matching attributes of the portion of the captured image 515. In the example of FIG. 5, the online concierge system 140 identifies 520 item 510A, item 510B, and item 510C as included in the captured image 515. Identifying one or more items from the captured image 515 leverages information from the captured image 515 to identify items in the checkout line 500 where the picker is located, providing the online concierge system 140 with current information about items in the retailer that are within a threshold distance of the picker while in the checkout line 500.

Based on characteristics of the customer from whom the order was received and attributes of each identified item 510 from the captured image 515, the online concierge system 140 selects a subset of the identified items, as further described above in conjunction with FIG. 3. In various embodiments, the online concierge system 140 determines a probability of the customer from whom the order was received performing a specific interaction (e.g., including an identified item in the order) for each identified item. The online concierge system 140 may determine the probability for an identified item by applying one or more models to a combination of the identified item and the customer. In some embodiments, the online concierge system 140 ranks the identified items based on their corresponding probabilities and selects identified items having at least a threshold position in the ranking as the subset of identified items. The online concierge system 140 may select identified items using additional or alternative criteria in various embodiments.

In some embodiments, the online concierge system 140 accounts for compensation received from the retailer or from an entity associated with one or more identified items in response to the customer performing the specific interaction with an identified item. For example, the online concierge system 140 generates a score for each identified item, with a score for an identified item based on a combination of a predicted probability of the customer performing the specific interaction with the identified item and an amount of compensation the online concierge system 140 receives in response to the customer performing the specific interaction with the item, as further described above in conjunction with FIG. 3. The online concierge system 140 ranks the identified items by their corresponding scores to select the subset of identified items.

To simplify selection of an identified item for inclusion in the order by the customer, the online concierge system 140 generates a message 525 including information describing various identified items of the subset. As further described above in conjunction with FIGS. 3 and 4, the message 525 includes text content and information describing various identified items of the subset in some embodiments. The text content may specify a time interval until the picker begins checking out of the retailer, providing the customer with a length of time during which the customer may add one or more identified items.

In some embodiments, the message 525 includes a carousel portion that includes a plurality of slots, with each slot presenting information describing a different identified item of the subset. For example, each slot in the carousel portion includes an image and a name (or a description) of an item of the subset. Other information describing an identified item may be retrieved from the item catalog for the retailer and included in the message 525. Additional examples of information describing an identified item include: a size of the identified item, a price of the identified item at the retailer, a weight of the item, nutritional information of the item, or other descriptive attributes of the item. In various embodiments, the message 525 presents information describing different identified items of the subset in an order based on the ranking used to select the subset. For example, the message includes different slots for presenting information describing different identified items, with each slot associated with a position in the ranking. So, a specific slot presents information describing an identified item of the subset having a position in the ranking associated with the specific slot. This allows the message 525 to present certain identified items in positions that increase a probability of the customer selecting one or more of the certain identified items.

The online concierge system 140 transmits the message 525 to the customer client device 100 of the customer for presentation. In various embodiments, the customer client device 100 presents the message 525 via a communication interface that includes text-based messages exchanged between the customer and the picker. For example, the picker and the customer exchange text-based messages as the picker fulfills the order, allowing the customer to provide information or feedback to the picker for fulfilling the order. The communication interface may present the message 525 as originating from the picker in some embodiments. Presenting the message 525 via the communication interface increases a likelihood of the customer viewing or interacting with the message 525 by using an interface through which the customer and picker exchanged content.

As further described above in conjunction with FIG. 3, in response to receiving a specific action by the customer with information describing an identified item of the subset included in the message 525, the customer client device 100 transmits a selection of the identified item to the online concierge system 140, which updates the order to include the selected identified item and transmits an identification of the selected identified item to the picker client device 110 in a request for the picker to obtain the selected identified item. This allows the customer to easily select one or more items near the picker for inclusion in the order while the picker checks out from the retailer, providing increased flexibility to the customer for adding various items to the order and increasing an amount of time when the customer may add items to the order.

In response to receiving a modified order status from the picker, such as an order status indicating the picker has completed checking out from the retailer, the online concierge system 140 prevents the customer from selecting an identified item via the message 525. For example, in response to receiving a modified order status from the picker that the picker has completed checking out of the retailer, the online concierge system 140 transmits an instruction to the client device 100 disabling selection of an identified item from the message 525 via the communication interface. The online concierge system 140 may transmit an additional message to the customer client device 100 in response to receiving the modified order status from the picker, with the additional message indicating that the customer is no longer able to include an identified item from the message in the order. This prevents the customer from attempting to select one or more identified items for inclusion in the order after the picker has completed checking out from the retailer.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a non-transitory computer readable medium, comprising:
receiving, at an online system, an order status from a picker client device indicating a picker fulfilling an order for a customer from a retailer is in a checkout line at the retailer;
receiving, at the computer system, an image of items in the checkout line from the picker client device, the image captured by the picker client device;
identifying, by the computer system, one or more items included in the image;
generating, using a trained machine learning model, one or more probabilities of the customer performing a specific interaction with different identified items;
ranking the identified items based on the generated probabilities of the customer performing a specific interaction with different identified items;
selecting a subset of identified items based on the ranking;
generating, by the computer system, a message including information describing one or more identified items of the subset; and
transmitting the message from the computer system to a client device of the customer for presentation in a communication interface displaying messages between the customer and the picker.

2. The method of claim 1, further comprising:
receiving, at the computer system, a selection of an identified item via the communication interface from the customer client device; and
transmitting an identification of the selected identified item and a request to include the selected identified item in the order to the picker client device for presentation to the picker.

3. The method of claim 1, wherein transmitting the message from the online system to a client device of the customer comprises:
modifying the order to include the selected identified item;
storing the modified order at the computer system; and
transmitting an identification of the selected identified item and a request to pick the item to the picker client device.

4. The method of claim 1, further comprising:
receiving a modified order status at the online system from the picker client device, the modified order status indicating the picker has completed checking out from the retailer; and
transmitting an instruction from the online system to the customer client device preventing selection of one or more identified items of the subset via the communication interface.

5. The method of claim 4, wherein transmitting the instruction from the online system to the customer client device preventing selection of one or more identified items of the subset via the communication interface comprises:
transmitting an additional message from the online system to the customer client device indicating the customer is unable to select one or more identified items of the subset via the communication interface; and
transmitting the instruction from the online system to the customer client device.

6. The method of claim 1, wherein generating, by the computer system, the message including information describing one or more identified items of the subset comprises:
generating text content including a time interval;
generating a carousel portion including a plurality of slots, each slot displaying information describing an identified item of the subset; and
generating the message including the text content and the carousel portion.

7. The method of claim 6, wherein the text content is generated by applying a large language model to a prompt including: instruction to generate text indicating the picker is checking out, an identifier of the picker, and an estimated amount of time until the picker completes checking out of the retailer.

8. The method of claim 1, wherein the trained machine learning model is trained by:
obtaining a training dataset including a plurality of training examples, each training example including characteristics of a training customer and attributes of an item, each training example having a label indicating whether the training customer performed the specific interaction with the item;
applying the machine learning model to each training example of the training dataset to generate a predicted probability of the training customer performing the specific interaction with the item;
scoring the machine learning model using a loss function and the label of the training example; and
updating one or more parameters of the machine learning model by backpropagation based on the scoring until one or more criteria are satisfied.

9. The method of claim 1, wherein the specific interaction with an identified item comprises the customer including the identified item in the order.

10. A computer program product comprising a non-transitory computer readable storage medium having instructions encoded thereon that, when executed by a processor, cause the processor to perform steps comprising:
receiving, at an online system, an order status from a picker client device indicating a picker fulfilling an order for a customer from a retailer is in a checkout line at the retailer;
receiving, at the online system, an image of items in the checkout line from the picker client device, the image captured by the picker client device;
identifying, by the online system, one or more items included in the image;
generating, using a trained machine learning model, one or more probabilities of the customer performing a specific interaction with different identified items;
ranking the identified items based on the generated probabilities of the customer performing a specific interaction with different identified items;
selecting a subset of identified items based on the ranking;
generating, by the online system, a message including information describing one or more identified items of the subset; and
transmitting the message from the online system to a client device of the customer for presentation in a communication interface displaying messages between the customer and the picker.

11. The computer program product of claim 10, wherein the non-transitory computer readable storage medium further has instructions encoded thereon that, when executed by the processor, cause the processor to perform steps comprising:
receiving, at the online system, a selection of an identified item via the communication interface from the customer client device; and
transmitting an identification of the selected identified item and a request to include the selected identified item in the order to the picker client device for presentation to the picker.

12. The computer program product of claim 10, wherein transmitting the message from the online system to a client device of the customer comprises:
modifying the order to include the selected identified item;
storing the modified order at the online system; and
transmitting an identification of the selected identified item and a request to pick the item to the picker client device.

13. The computer program product of claim 10, wherein the non-transitory computer readable storage medium further has instructions encoded thereon that, when executed by the processor, cause the processor to perform steps comprising:
receiving a modified order status at the online system from the picker client device, the modified order status indicating the picker has completed checking out from the retailer; and
transmitting an instruction from the online system to the customer client device preventing selection of one or more identified items of the subset via the communication interface.

14. The computer program product of claim 13, wherein transmitting the instruction from the online system to the customer client device preventing selection of one or more identified items of the subset via the communication interface comprises:
transmitting an additional message from the online system to the customer client device indicating the customer is unable to select one or more identified items of the subset via the communication interface; and
transmitting the instruction from the online system to the customer client device.

15. The computer program product of claim 10, wherein generating, by the online system, the message including information describing one or more identified items of the subset comprises:
generating text content including a time interval;
generating a carousel portion including a plurality of slots, each slot displaying information describing an identified item of the subset; and
generating the message including the text content and the carousel portion.

16. The computer program product of claim 15, wherein the text content is generated by applying a large language model to a prompt including: instruction to generate text indicating the picker is checking out, an identifier of the picker, and an estimated amount of time until the picker completes checking out of the retailer.

17. The computer program product of claim 10, wherein the trained machine learning is trained by:
obtaining a training dataset including a plurality of training examples, each training example including characteristics of a training customer and attributes of an item, each training example having a label indicating whether the training customer performed the specific interaction with the item;
applying the machine learning model to each training example of the training dataset to generate a predicted probability of the training customer performing the specific interaction with the item;
scoring the machine learning model using a loss function and the label of the training example; and
updating one or more parameters of the machine learning model by backpropagation based on the scoring until one or more criteria are satisfied.

18. The computer program product of claim 10, wherein the specific interaction with an identified item comprises the customer including the identified item in the order.

19. A system comprising:
a processor; and
a non-transitory computer readable storage medium having instructions encoded thereon that, when executed by the processor, cause the processor to perform steps comprising:
receiving, at an online system, an order status from a picker client device indicating a picker fulfilling an order for a customer from a retailer is in a checkout line at the retailer;
receiving, at the online system, an image of items in the checkout line from the picker client device, the image captured by the picker client device;
identifying, by the online system, one or more items included in the image;
generating, using a trained machine learning model, one or more probabilities of the customer performing a specific interaction with different identified items;
ranking the identified items based on the generated probabilities of the customer performing a specific interaction with different identified items;
selecting a subset of identified items based on the ranking;
generating, by the online system, a message including information describing one or more identified items of the subset; and
transmitting the message from the online system to a client device of the customer for presentation in a communication interface displaying messages between the customer and the picker.

20. The system of claim 19, wherein the non-transitory computer readable storage medium further has instructions encoded thereon that, when executed by the processor, cause the processor to perform steps comprising:
receiving, at the online system, a selection of an identified item via the communication interface from the customer client device; and
transmitting an identification of the selected identified item and a request to include the selected identified item in the order to the picker client device for presentation to the picker.
